(19) United States
(12) Patent Application Publication
(10) Pub. No.: US 2025/0372289 A1
(43) Pub. Date: Dec. 4, 2025

(54) DEVICE COMPRISING A MAGNETIC FIELD GENERATOR, AND METHOD FOR PROVIDING A COIL ARRANGEMENT

(71) Applicant: Christian-Albrechts-Universitaet zu Kiel, Kiel (DE)

(72) Inventors: Henrik WOLFRAMM, Kiel (DE); Michael HOEFT, Laboe (DE)

(73) Assignee: Christian-Albrechts-Universitaet zu Kiel, Kiel (DE)

(21) Appl. No.: 19/305,309

(22) Filed: Aug. 20, 2025

Related U.S. Application Data
(63) Continuation of application No. PCT/EP2023/054193, filed on Feb. 20, 2023.

(51) Int. Cl. H01F 5/00; G01R 33/00; G06F 30/373; G06F 30/392; G06F 113/18; H01F 41/04

(52) U.S. Cl. CPC H01F 5/003; G01R 33/0017; G06F 30/373; G06F 30/392; H01F 41/042; G06F 2113/18

(57) ABSTRACT

A device comprising at least one magnetic field generator, which in turn comprises a coil arrangement with multiple coils that have multiple windings each. The invention further relates to a method for providing a coil arrangement for such a device.

This nonprovisional application is a continuation of International Application No. PCT/EP2023/054193, which was filed on Feb. 20, 2023, and is herein incorporated by reference.

### BACKGROUND OF THE INVENTION

### Field of the Invention

The invention relates to a device comprising at least one magnetic field generator, which in turn comprises a coil arrangement with multiple coils that have multiple windings each. The invention further relates to a method for providing a coil arrangement for such a device.

### Description of the Background Art

The device is particularly suitable for testing, characterizing and/or calibrating magnetic field sensors. It is known to use permanent magnets or very large coil arrangements for this purpose, such as a Helmholtz coil or a cylindrical coil that surrounds the magnet-sensitive element of a magnetic field sensor. However, the conventional devices are relatively inflexible in their possible applications and sometimes also very space-and cost-intensive. In addition, the generation of reproducible homogeneous magnetic fields is problematic in such arrangements.

### SUMMARY OF THE INVENTION

It is therefore an object of the invention to provide an improved device with at least one magnetic field generator with which the mentioned disadvantages are overcome. In addition, a method for providing a coil arrangement for such a device is to be specified.

This object is achieved, in an example, by a device comprising at least one magnetic field generator, which in turn comprises a coil arrangement with multiple coils that have multiple windings each, wherein the coil arrangement has a first planar coil layer with at least one coil and a second planar coil layer with at least one coil arranged parallel to it, wherein the second planar coil layer is arranged at a distance from the first planar coil layer, wherein the coil arrangement is designed to generate a parallel magnetic field at a distance from the first coil layer on the side of the first coil layer facing away from the second coil layer when the coil arrangement is electrically energized, which has magnetic field lines parallel to the first coil layer. The parallel magnetic field is thus a magnetic field directed tangentially to the plane of the first planar coil layer.

The second planar coil layer can thus be arranged in a plane parallel to the plane of the first planar coil layer and thus not in the same plane. For example, the coils of the first and the second planar coil layer can have their aerial extent in the x and y coordinate directions. The second planar coil layer is then somewhat spaced from the first planar coil layer in the z direction. The coils of the first planar coil layer can be arranged overlapping with the coils of the second planar coil layer.

Such a coil arrangement with a first and a second planar coil layer can be provided relatively easily and inexpensively, e.g., by means of traces in corresponding trace layers of a printed circuit board (PCB). In addition, the above-mentioned design of the coil arrangement can generate a relatively homogeneous magnetic field directed in a desired direction outside the area surrounded by the coil layers, i.e., the magnetic field sensor does not have to be arranged between the coil layers.

For example, the desired parallel magnetic field can be generated at a distance from the first coil layer that is at least 50% of the distance between the first coil layer and the second coil layer. As mentioned, the first coil layer and the second coil layer are designed as planar coil layers, i.e., planar coils are realized in the invention, whose coil windings are thus arranged in one plane. For example, the first planar coil layer can have two coils. The second planar coil layer can have two coils.

The invention allows for an advantageous, relatively inexpensive generation of directional and homogeneous magnetic fields in the sensitive plane of a magnetic field sensor without the need for wire-wound coils. The coil arrangement of the magnetic field generator according to the invention can accordingly be realized relatively small, e.g., on an electrical circuit board. Compared to the use of permanent magnets, the invention has the advantage that by controlling the current supply of the coil arrangement the magnetic field can be adjusted in the desired way and can be changed in the operation of the device as desired. The parallel magnetic field generated by the magnetic field generator can be used to characterize a magnetic field sensor, to set its operating point and/or to compensate for external fields.

Another advantage of the invention is that the coils of the coil arrangement can be produced cost-effectively and reproducibly, e.g., by using existing, widespread and established manufacturing techniques, such as the production of electrical circuit boards. It is advantageous to use a usually unused space on the PCB to accommodate the coil arrangement, whereas the PCB otherwise serves as a carrier and as protection for the magnetic field sensor. This allows for the provision of a proprietary and stable coil system associated with the magnetic field sensor, which is suitable for system calibration and characterization. A device with such a magnetic field generator can be implemented with a coil design that is particularly robust against external interference fields.

The device according to the invention can be used to characterize and calibrate a magnetic field sensor. It is also possible to exert a desired influence on its behavior during operation, e.g., by influencing the sensor characteristic curve through the parallel magnetic field and its control.

The coil arrangement can be designed with only two external connections through which an electrical current can be fed into the coil arrangement.

At least one coil of the first coil layer can have a counter-rotating winding direction to the at least one coil of the second coil layer. This allows for a parallel magnetic field to be generated in a particularly favorable manner outside the area surrounded by the first and second coil layers, i.e., beyond the coil arrangement.

The coils of the first coil layer and/or the second coil layer can be formed by traces of a printed circuit board (PCB). The traces form coil-like conductor loops. This allows for a simple, reproducible, cost-effective and robust realization of the coil arrangement.

The printed circuit board can have multiple trace layers, wherein the first coil layer is formed on a first trace layer (trace layer) and the second coil layer is formed on a second trace layer spaced from it. In this case, it is sufficient if a PCB with two trace layers is used, for example a PCB coated on both sides with trace material. Then, the first coil layer can be realized on one trace layer of the PCB, and the second coil layer on the other trace layer. The distance between the first and second coil layers of a two-layer PCB is essentially the same as the thickness of the PCB. It is also possible to use multilayer PCBs. For example, one printed circuit board with four trace layers can also be used. Then, for example, the trace layers arranged inside the PCB can be used for the realization of the coil arrangement.

Traces of the first coil layer are connected to traces of the second coil layer by one or more vias. In this way, a relatively complex coil system can be easily and inexpensively realized in printed circuit board technology.

The first coil layer in the area covered by the parallel magnetic field can have a greater distance between windings of the at least one coil than outside the area covered by the parallel magnetic field. This ensures a high homogeneity of the parallel magnetic field. If the windings are realized as traces, the first coil layer has a greater distance between traces in the area covered by the parallel magnetic field than outside the area covered by the parallel magnetic field.

The second coil layer can have concave curved windings or trace sections which are immediately adjacent to the area covered by the parallel magnetic field. In this way, the traces can be guided around the area of the coil arrangement covered by the parallel magnetic field. This also ensures a particularly good homogeneity of the parallel magnetic field.

The device can have at least one magnetic field sensor, in particular a magnetic field sensor in thin-film technology, with a magnet-sensitive element arranged in the area of the parallel magnetic field. In this way, an integrated device can be realized that has both a magnetic field sensor and a magnetic field generator assigned to the magnetic field sensor. The magnetic field generator can be used to measure and/or calibrate the magnetic field sensor. The magnetic field generator can also influence the sensor properties of the magnetic field sensor during operation, e.g., by changing the characteristic curve of the magnetic field sensor in a desired way by controlling the parallel magnetic field.

The object mentioned above is also achieved by a method for providing a coil arrangement of a device of the type previously explained, with the following steps: (a) determining the installation space available for the coil arrangement; (b) defining a desired area in which the coil arrangement is to generate the parallel magnetic field; (c) arranging the traces of the first coil layer and the second coil layer on a printed circuit board, especially a virtual arrangement of the traces in a CAD program; (d) simulating the magnetic field that can be generated by the coil arrangement, checking as to whether the parallel magnetic field meets the requirements set; and (e) if the requirements are not met, continuing the process in step c), otherwise terminating the process.

This also allows for the advantages explained above to be realized. In particular, this can provide a coil arrangement for a magnetic field generator, which can generate a very homogeneous and relatively strong parallel magnetic field in the desired area.

According to an example of the invention, it is provided that the following sub-steps can be carried out in step c): c1) Distribution of the traces in the first and second coil layers, c2) determination of coil center distance and core diameter, and c3) connection of the traces to coil-like conductor loops.

This allows for the homogeneity of the parallel magnetic field to be further improved or iteratively optimized.

According to an advantageous embodiment of the invention, it is provided that after step (c) and before step (d), it is checked whether the distribution of the traces in the second coil layer is sufficiently suitable for the specified generation of the parallel magnetic field, and if this is not the case, the defined core diameter is increased and step (c2) is performed, otherwise step (d) is performed. In this way, the coil arrangement and thus the magnetic field generator can be iteratively optimized for the desired application. For example, a software simulation of the expected parallel magnetic field can be carried out for the execution of the method step and optimization can be carried out on the computer in one or more iterative steps during the coil design.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a magnetic field generator in perspective view,

FIG. 2 shows the magnetic field generator according to FIG. 1 with a magnetic field sensor,

FIG. 3 shows a lateral sectional view through the device according to FIG. 2 with representation of the magnetic field,

FIG. 4 shows winding of a coil arrangement of the magnetic field generator according to FIG. 1 in a plan view,

FIGS. 5 and 6 show dimensioning options of the coils according to FIG. 3, and

FIG. 7 shows the flow of a method for providing a coil arrangement according to FIG. 3.

### DETAILED DESCRIPTION

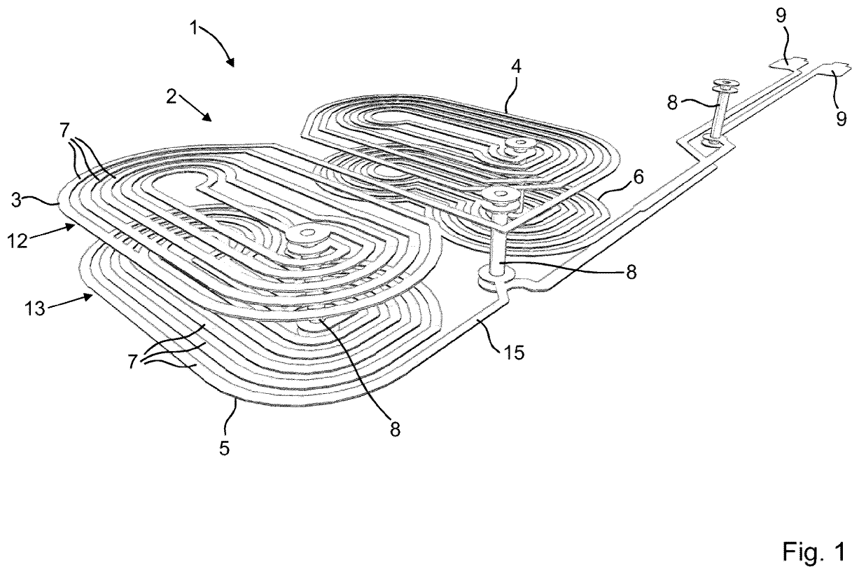

FIG. 1 shows a device 1 with a magnetic field generator 2, comprising a coil arrangement with multiple coils 3, 4, 5, 6. The coils 3, 4, 5, 6 are designed as planar coils with multiple windings 7. Coils 3, 4 are located in a first planar coil layer 12, i.e., in the same plane, and coils 5, 6 are located in a second planar coil layer 13 arranged parallel to the first coil layer 12, i.e., in a plane parallel to the coil layer 12. Coils 3, 4 are connected to each other by a line. Coil 3 is connected to coil 5 by a via 8. Coil 4 is connected to coil 6 by a via 8. The coil arrangement 2 has two external connections 9, through which an electrical signal can be applied to the coil arrangement 2, which flows through the coils 3, 4, 5, 6. This allows for a parallel magnetic field, which has parallel magnetic field lines to the first coil layer 12 and is spaced from the first coil layer 12, to be generated on the side of the first coil layer 12 facing away from the second coil layer 13.

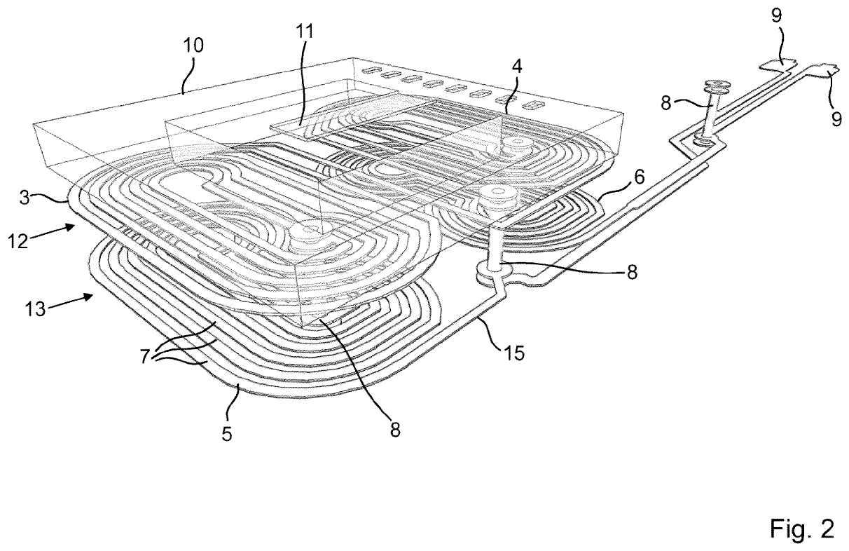

FIG. 2 shows the combination of the device 1 with the coil arrangement 2 with a magnetic field sensor 10, which has a magnet-sensitive element 11. The magnet-sensitive element 11 is arranged in the area of the parallel magnetic field that can be generated by the coil arrangement 2.

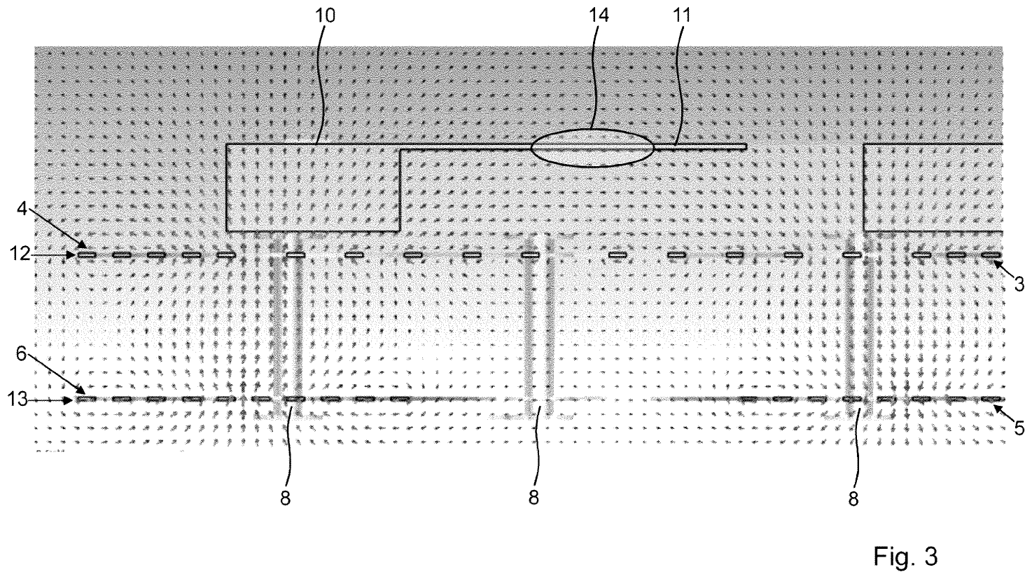

FIG. 3 illustrates this by means of a lateral sectional view. Again, the coils 3, 4 in the first coil layer 12 and the coils 5, 6 in the second coil layer 13 can be seen. The vias 8 are also visible. The magnetic field sensor 10 with the magnet-sensitive element 11 is arranged above the first coil layer 12. The arrows illustrate the course of the magnetic field lines. Above the first coil layer 12, the aforementioned parallel magnetic field 14 is generated. The x and y components of the magnetic field lines in the area of the parallel magnetic field 14 are relatively homogeneous and also parallel to the plane of the first coil layer 12 and accordingly also tangential to the longitudinal extension of the magnet-sensitive element 11.

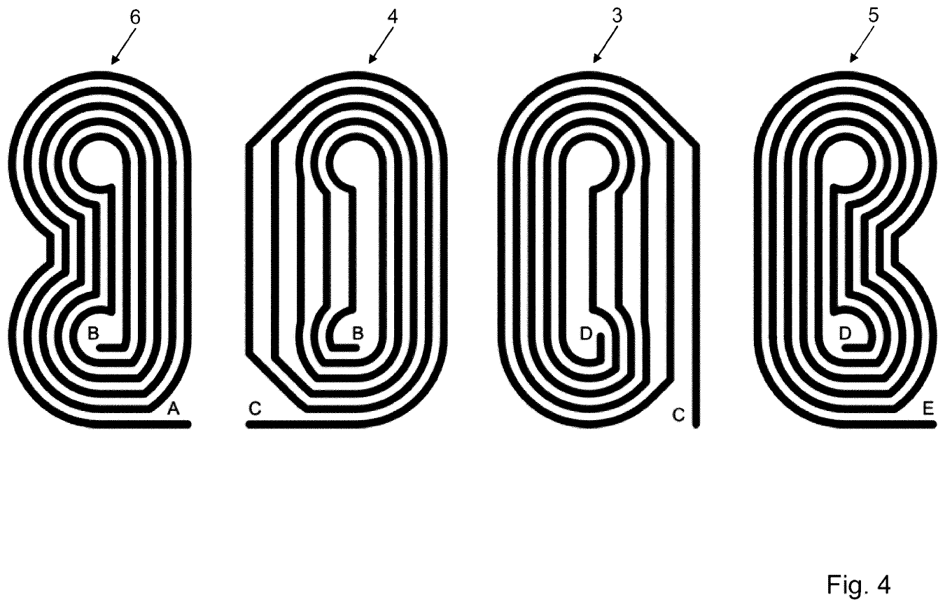

FIG. 4 illustrates an advantageous embodiment of the coils 3, 4, 5, 6 as well as an advantageous option of connection between these coils. Coils 3, 4, 5, 6 are connected in series. Coil 6 is connected to coil 4 at junction point B by a via. Coil 3 is connected to coil 5 at junction point D by a via. Coils 3 and 4 are connected to each other at connection points C directly or via a trace piece in the same coil layer. The connection points A and E are connected to the external connections 9.

The coils 5, 6 in the second (lower) coil layer 13 ensure the highest possible magnetic field strength and accordingly sensitivity. Coils 3, 4 in the first (upper) coil layer 12 direct the magnetic field into a tangential plane to the first coil layer or to an electrical circuit board in which the first and second coil layers are realized and establish a homogeneous field distribution in the area of the parallel magnetic field 14.

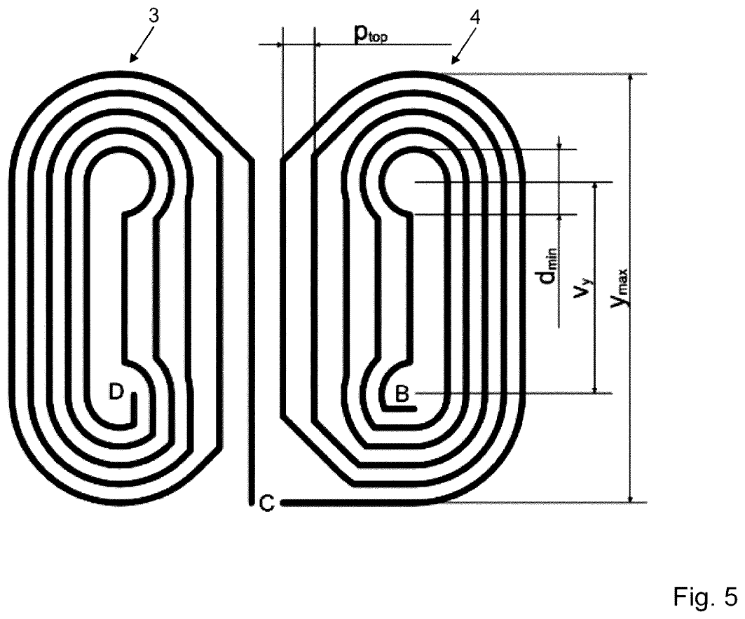

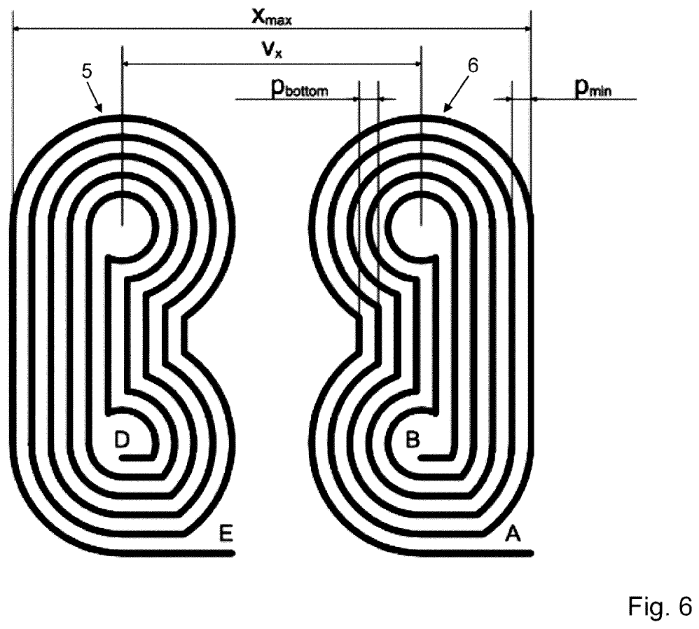

With reference to the parameters of the coils 3, 4, 5, 6 given in FIGS. 5 and 6, the following advantageous method for dimensioning the coils by means of traces on a printed circuit board is proposed.

The following relevant parameters for dimensioning must be observed:
xₘₐₓ: Maximum available installation space in the x direction (field direction of the parallel magnetic field 14)
yₘₐₓ: Maximum available installation space in the y direction
dₘᵢₙ: Minimum radius of an internal conductor loop
vₓ: Coil center distance in x direction
v_{y}: Core diameter of a pair of coils
pₘᵢₙ: Minimum trace distance to be realized
pₜₒₚ: Distance of the inner traces of the coils 3, 4 (coil top)
p_{bottom}: Distance between the inner traces of the coils 5, 6 (coil bottom)

### Design and Dimensioning of the Coils:

1. The dimensions xₘₐₓ and yₘₐₓ denote the complete installation space required by the coils. This should be chosen as large as possible. A high number of windings, which can be achieved in a large installation space, is advantageous in terms of the homogeneity of the field and the maximum field strength that can be achieved.
2. vₓ and c_{y} denote the coil center distance of a pair of coils or the core diameter of a single coil. The largest possible v_{y} reduces the field gradient in the y direction. It should be chosen at least so large that all line sections run below the desired field level without curvatures. vₓ should be at least 1.7 times the length of the targeted field level. Furthermore, vₓ must be >(yMax−vy). A larger distance is advantageous in terms of homogeneity.
3. dₘᵢₙ is the minimum diameter, or 2 times the minimum radius of the innermost conductor loop. This results from the PCB technology used and the specifications of the PCB manufacturer. The limiting factor here is usually the minimum distance between a set via for the connection of the upper and lower coil and a trace running past it. A small dₘᵢₙ leads to a more effective use of the possible installation space.
4. The trace spacing pₘᵢₙ is given by the design specifications of the PCB manufacturer and the selected trace width. The trace width (not specified in the drawing here) should be chosen as large as necessary to achieve a low ohmic resistance in the coil, but also as small as possible to achieve a maximum number of windings.
5. The trace spacing p_{bottom} should be equal to pₘᵢₙ for a homogenous magnet field. A minimum magnification of p_{bottom} results in an increase in the maximum achievable field in the targeted field plane, with only a slight deterioration in homogeneity.
6. pₜₒₚ must be chosen so that the traces are evenly distributed over the free surface. If n is the number of windings per individual coil, then pₜₒₚ=(vx+dmin)/(2n+1).
7. The distance between the upper (coil top) and the lower coil (coil bottom) is based on the selected PCB technology (not specified in the drawing here). However, a distance should be aimed for that roughly corresponds to that between the upper coil and the desired field plane of the parallel magnetic field 14.
8. All traces that are not specified in more detail should be designed with a focus on minimum line length and maximum symmetry of the entire coil structure.

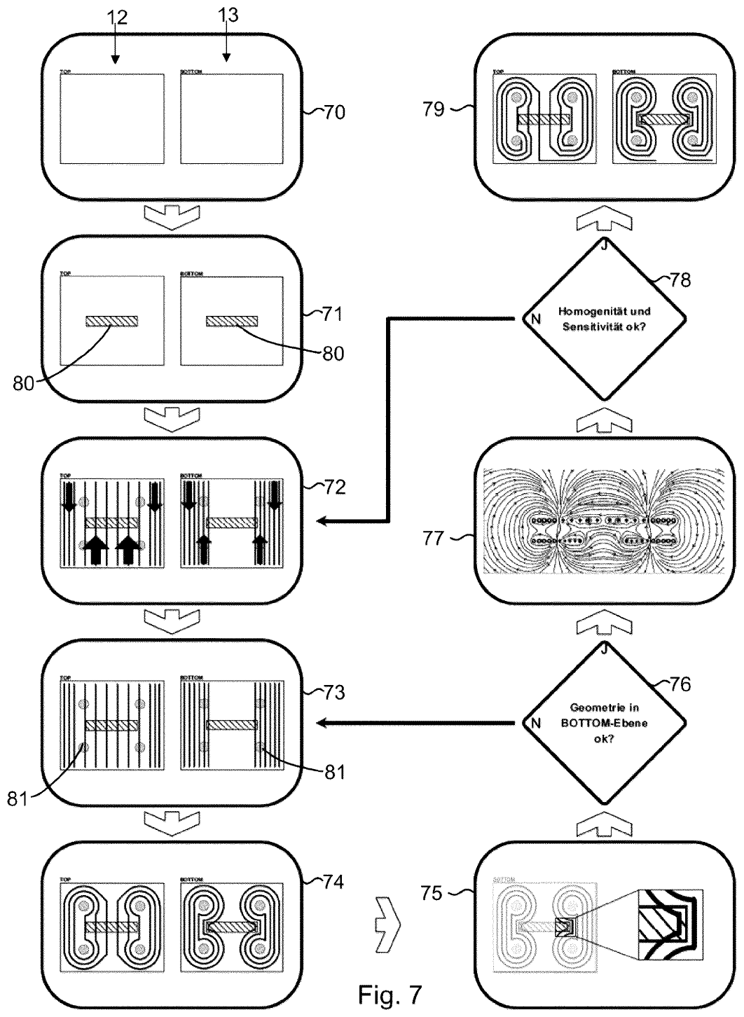

An advantageous method for providing such a coil arrangement 2 can be carried out as shown in FIG. 7.

In step 70, the available installation space can first be defined. The installation space should be chosen to be as large as possible. It has a direct influence on the number of coil windings to be realized and thus also on the achievable field strength and field homogeneity. In particular, when it is implemented on a printed circuit board, the installation space available on the printed circuit board must be taken into account.

In a subsequent step 71, a target range can be defined. The target range is the area in which the parallel magnetic field to be generated tangentially to the PCB surface is to be generated during the coil arrangement and should be as homogeneous as possible. For example, the surfaces 80 can be defined as the target range, which are, so to speak, a projection of the parallel magnetic field to be generated into the areas of the planar coil layers.

In step 72, the distribution of the traces on the PCB is then carried out in the coil planes, i.e., in the first coil layer and the second coil layer. It is advantageous to place the outer traces as closely as possible in the first coil layer. The inner traces should make equal use of the available space. Furthermore, it is advantageous to place all traces as far as possible on the outside in the second coil layer and to essentially not cover the target area 80.

In step 73, the coil center distance and core diameter are then determined. The maximum values for coil center distance and core diameter are defined by the trace width, trace spacing, and number of coil windings. In addition, areas 81 can already be reserved for the vias 8.

In step 74, the traces are connected to conductor loops. As you can see, in the first coil layer the conductor loops can at least partially cover the target range 80. In the second coil layer, the conductor loops are formed in such a way that the target range 80 is essentially omitted. In this way, for example, two coils in a glasses-like shape can be created in the second coil layer 13. In general, the traces should be connected to conductor loops in the shortest possible manner. The connection is made with circular tracks and traces at a 45-degree angle.

In step 75, the traces are then distributed in the coil planes, i.e., the first coil layer and the second coil layer. For example, the conductor loop geometry can be evaluated in the second coil layer: If there are no or only very short straight conductor paths, so that the target area 80 is too covered, the core diameter can be increased, for example.

In a step 76, it is checked whether the geometry in the second coil layer is suitable for meeting the requirements for the parallel magnetic field 14 to be generated. If this is not the case, step 73 is carried out, e.g., by increasing the core diameter in the second coil layer 13.

Otherwise, step 77 is performed after step 76. There, the magnetic field resulting from the current supply of the coil arrangement can be checked by simulation, at least in the X direction. For example, relevant evaluation criteria for the suitability of the resulting magnetic field can be the homogeneity of the magnetic field in the plane of the desired parallel magnetic field, i.e., in the target range, as well as the sensitivity of the coil arrangement in relation to the target range in T/A.

In step 78, the parameters determined by the simulation are checked, for example whether the homogeneity and sensitivity reach the desired values. If this is not the case, the system branches back to step 72. For example, the homogeneity of the magnetic field can then be improved there by changing the number of windings and/or the coil center distance. If the field strength is insufficient, a change in the number of windings and/or the distance between the traces in the second coil layer can be changed, for example.

If step 78 determines that the desired criteria are met, step 79 is performed. There, the conductor loops are connected to a coil system, i.e., to the finished coil arrangement 2 as shown in FIG. 1. For example, the conductor loops can be connected in such a way that the impairment of symmetry is as low as possible. The four individual coils are then connected in series. The above steps can be performed in whole or at least in part in a PCB design program.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device comprising at least one magnetic field generator, which in turn comprises a coil arrangement with at least two coils that have multiple windings each, the coil arrangement comprising:
a first planar coil layer comprising at least one coil; and
a second planar coil layer that is substantially parallel to the first planar coil layer, the second planar coil layer comprising at least one coil,
wherein the second planar coil layer is arranged at a distance from the first planar coil layer, and
wherein the coil arrangement is set up to generate a parallel magnetic field on a side of the first coil layer facing away from the second coil layer at a distance from the first coil layer when the coil arrangement is electrically energized, which has parallel magnetic field lines to the first coil layer.

2. The device according to claim 1, wherein the at least one coil of the first coil layer has a counter-rotating winding direction to the at least one coil of the second coil layer.

3. The device according to claim 1, wherein the coils of the first coil layer and/or the second coil layer are formed by traces of a printed circuit board.

4. The device according to claim 3, wherein the printed circuit board has multiple trace layers, and wherein the first coil layer is formed on a first trace layer and the second coil layer is formed on a second trace layer spaced from the first trace layer.

5. The device according to claim 3, wherein traces of the first coil layer are connected by one or more vias to traces of the second coil layer.

6. The device according to claim 1, wherein the first coil layer in an area covered by the parallel magnetic field has a greater distance between windings of the at least one coil than outside an area covered by the parallel magnetic field.

7. The device according to claim 1, wherein the second coil layer has concave curved windings or trace sections, which are immediately adjacent to the area covered by the parallel magnetic field.

8. The device according to claim 1, wherein the device comprises at least one magnetic field sensor, or a magnetic field sensor in thin film technology, with a magnet-sensitive element arranged in the area of the parallel magnetic field.

9. A method for providing a coil arrangement of a device according to claim 1, the method comprising:
a) determining an installation space available for the coil arrangement;
b) defining a desired area in which the coil arrangement is to generate the parallel magnetic field;
c) arranging the traces of the first coil layer and the second coil layer on a printed circuit board, especially a virtual arrangement of the traces in a CAD program;
d) simulating the magnetic field generatable by the coil arrangement, and checking as to whether the parallel magnetic field meets the requirements set; and
e) if the requirements are not met, continuing the process in step c), otherwise terminating the process.

10. The method according to claim 9, wherein the following sub-steps are carried out in step (c):
c1) distributing the traces in the first and second coil layers;
c2) determining coil center distance and core diameter; and
c3) connecting the traces to coil-like conductor loops.

11. The method according to claim 9, wherein, after step (c) and before step (d), it is checked whether the distribution of the traces in the second coil layer is sufficiently suitable for the specified generation of the parallel magnetic field, and if this is not the case, the defined core diameter is increased and step (c2) is performed, otherwise, step d) is performed.
